(19) United States
(12) Patent Application Publication
(10) Pub. No.: US 2015/0019268 A1
(43) Pub. Date: Jan. 15, 2015

(54) DETERMINATION OF ACTIVITY RATE OF PORTABLE ELECTRONIC EQUIPMENT

(71) Applicant: Movelo AB, Stockholm (SE)

(72) Inventors: Peter Händel, Stockholm (SE); Martin Ohlsson, Taby (SE); Isaac Skog, Stockholm (SE); Jens Ohlsson, Stocksund (SE)

(73) Assignee: Movelo AB, Stockholm (SE)

(21) Appl. No.: 14/377,689

(22) PCT Filed: Feb. 8, 2013
(86) PCT No.: PCT/SE2013/050106

§ 371 Date: Aug. 8, 2014

(30) Foreign Application Priority Data
Feb. 9, 2012 (SE) 1230015-8

(51) Int. Cl. G06Q 40/08; H04W 4/02

(52) U.S. Cl. CPC G06Q 40/08; H04W 4/027
USPC 705/4

(57) ABSTRACT

A method for obtaining activity rate of a portable electronic device (250) during travel with a vehicle (200) comprises determining (S100) a calculated driving distance based on the portable electronic device utilizing a sequence of measured positions for the portable electronic device. The method further comprises determining (S200) a read driving distance by reading of odometer indication (270) of the vehicle. The method also comprises calculating (S300) an activity rate by comparison of the calculated driving distance with the read driving distance. The method further comprises calculating (S400) a flag which indicates the validity of the calculated activity rate, where the flag is calculated based on the sequence of measured positions for the portable electronic device. The method also comprises transferring (S500) an information packet (280) to a central server (290), where the information packet comprises the activity rate, and/or the read driving distance, and/or the flag.

### TECHNICAL FIELD

The present invention generally relates to portable electronic devices such as mobile phones and more particularly to a method for obtaining an activity rate of a portable electronic device during travel with a vehicle.

### BACKGROUND

A car insurance premium P [SEK] for a private car is classically based on the classification of the vehicle owner and the vehicle in terms of vehicle type, driving distance, age, gender, geographical residence and number of damage free years. These are by necessity blunt instruments to determine an insurance premium. The EU Court of Justice has decided that from December 2012 insurance companies are no longer allowed to include the gender as a risk factor in insurances, which makes the instrument even more blunt. Obviously, similar calculation rules apply for other types of motor vehicles such as buses and trucks.

A fundamental factor for calculation of a traditional or behaviour-based insurance premium is annual driving distance of the vehicle, usually quantized in intervals such as: up to 10000 km per year, 10000-15000 km per year, and so on. Via sampling, at a new premium period, or at an accident, are occasions when the odometer indication of the vehicle is read to ensure that the vehicle is neither under- nor over-insured. There is today no technical obstacle for a premium model based on actual annual driving distance, for example 12300 km during a year, where adjustment of a pre-paid premium occurs at the anniversary date of the insurance.

Premium calculation based on actual driving behaviour has been discussed for many years but is associated with great challenges. A basic thought here is that the insurance holder may deliberately change his/her driving behaviour in order to influence his/her premium. We denote the price of such a behaviour-based premium with B [SEK] which, in order to be attractive to the insurance holder, should be lower than a classical premium P in the normal case. Through active monitoring of the vehicle speed a premium may be calculated from the speed profile of the vehicle under the assumption that increased speed yields an increased risk. Unfortunately this is not entirely true since high speed on a road without other road users implies a lower risk compared to many and sudden lane changes at low speed on a highly busy road.

So far, a fact within behaviour-based insurance models has been that the vehicle needs to be equipped with fixedly installed equipment for monitoring of driving behaviour. Typically, such equipment comprises functionality for positioning, speed monitoring, and detection of quick courses of events such as sudden braking and violent acceleration or evasive maneuvers. Furthermore, the information needs to be sent to a central server for example at the insurance company, which is preferably done progressively with wireless broadband or other wireless data communication.

When it comes to positioning and speed monitoring, a suitable tool is for example a receiver connected to one of the available satellite navigation systems (see also further below). Vehicle speed may also be monitored for example through equipment connected to the on-board diagnostic (OBD2) connection of the vehicle. When it comes to detection of quick courses of events, accelerometers and gyroscopes can be used, i.e. such sensors which are common within the vehicle industry and which are also used for applications such as air bags and traction control systems. The technical equipment and its installation in the vehicle imply expenses, indirectly or directly, to the insurance holder, since dedicated equipment is needed which must be installed by a specialist at a garage; with all the implications regarding time booking, travel times, lost work time and absence of the vehicle while it is at the garage.

The introduction of so-called Smartphones such as iPhone and Android-based phones such as for example HTC Desire has increased the availability of the information technology the functionality of the mobile phone has been multiplied from being a device for voice calls, to a device with a versatile field of application. In summary, a modern smart mobile phone has the sensors, the access to digital communication, and the computing capacity that is needed in order to monitor the travel of a vehicle and report e.g. driving behaviour to a central server, to be used for example for implementation of flexible premium models for the vehicle insurance.

The mobile phone is in fact in every man's possession, so a behaviour-based premium model may be implemented with the insurance holder's own equipment in the form of a mobile phone, through dedicated functionality utilizing the sensors and receivers of the mobile phone, its opportunities for computation power and digital wireless communication with a central server. For example, with an iPhone the functionality may be downloaded via a so-called app in App Store, or for an Android-based mobile phone via Android Market. Similar functionality is available for operating systems such as Unix, Linux, Windows and Windows Mobile.

A basic example of how a behaviour-based insurance premium for motor vehicles may be implemented is that the vehicle owner who is also the insurance holder installs an app in his/her iPhone which allows the driver behaviour to be monitored during travel. The behaviour may then be monitored with the aid of the built-in sensors of the mobile phone, which data is passed on to a central server as raw data from the sensors, or alternatively as signal processed data where the signal processing is performed by the built-in signal processing capacity of the mobile phone. Examples of different factors that are of interest to insurance companies for premium calculations are listed below, classified by type.

Behavioural factors which may influence the insurance premium are for example:
time of day that the vehicle is operated, which is registered by storing and processing of time stamps which are obtained from the clock of the mobile phone,
driving distance, which is obtained by summation of position differences, where the current positions are obtained from the GPS receiver or other GNSS receiver of the mobile phone,
speed, which is obtained from the GPS receiver or other GNSS receiver of the mobile phone,
strong accelerations, decelerations or evasive maneuvers which are detected by the built-in accelerometer (one- or multi-dimensional) of the mobile phone,
strong rotational changes which are detected by the built-in gyroscope (one- or multi-dimensional) of the mobile phone.

More qualifiedly calculated behavioural factors are for example how environment-friendly the driving is, based on calculated fuel consumption. It is well known that the fuel consumption may be calculated from vehicle data such as weight, cylinder volume, and friction coefficients; and/or sensor data comprising quantities such as speed and acceleration. Vehicle data is available via data bases such as for example the vehicle register, and sensor data via the built-in sensors of the mobile phone. An environment-friendly driving style is often denoted as eco-driving, or green driving.

Another example of a more qualified behavioural factor is to link the measured vehicle speed to the current speed limit of the road section, where the speed limit is available for example via an electronic map. For example, the Swedish National road data base (NVDB) from the Swedish Transport Administration provides up-to-date speed limits for the Swedish road network.

External factors which may influence the insurance premium are for example: weather and light conditions, road conditions, geography, presence at severely accident prone road sections, traffic volume, etc. These external factors may be obtained from external data bases, with knowledge of the position and time of the vehicle again available via the mobile phone.

Finally, internal factors may influence the insurance premium. These factors comprise for example fatigue, general health condition and concentration. These factors may be monitored by processing of accelerometer data from the built-in accelerometer of the mobile phone.

A conclusion that can be drawn from the discussion above is that the vehicle owner, also the insurance holder, needs to activate certain functionality in his/her mobile phone when travelling with the vehicle in order to enable implementation of monitoring of the driving behaviour via a mobile phone as described in the example above. If the mobile phone is not activated in the correct manner for a part of a trip or a complete trip, a behaviour-based insurance premium cannot be implemented for that trip. It is therefore important to know when the vehicle owner, also the insurance holder, has activated his/her mobile phone in a correct manner when travelling with the vehicle.

It is known in the art that the total premium can be based on a continuous monitoring during the full policy period, or a monitoring over a qualification period given by a predetermined distance and/or time period. In the latter case the premium of the policy period is given by the obtained premium level indicated by the qualification period. In Sweden, for example, one insurance company plans to use a qualification period of 2 weeks and 200 km as a basis for determining the premium for a 12 months' policy period.

### SUMMARY

It is an object to provide a method for obtaining an activity rate of a portable electronic device during travel with a vehicle.

An aspect relates to a method for obtaining activity rate of a portable electronic device during travel with a vehicle. The method comprises determining a calculated driving distance based on the portable electronic device utilizing a sequence of measured positions for the portable electronic device. The method further comprises determining a read driving distance by reading of odometer indication of the vehicle. The method also comprises calculating an activity rate by comparison of the calculated driving distance with the read driving distance. The method further comprises calculating a flag which indicates the validity of the calculated activity rate, where the flag is calculated based on the sequence of measured positions for the portable electronic device. The method also comprises transferring an information packet to a central server, where the information packet comprises the activity rate, and/or the read driving distance, and/or the flag.

Another aspect relates to a method for using the method as described above when calculating an insurance premium.

A further aspect relates to a method for calculating an insurance premium. The method comprises obtaining the activity rate of a portable electronic device in a vehicle during travel according to the method as described above. The method further comprises calculating the insurance premium by summation of a first part and a second part, where the first part increases when the activity rate increases and vice versa, the second part decreases when said activity rate increases and vice versa, and the insurance premium decreases when the activity rate increases.

Yet another aspect refers to a computer program for determining, when executed by a computer, activity rate of a portable electronic device during travel with a vehicle. The computer program comprises program element configured to determine a calculated driving distance based on the portable electronic device utilizing a sequence of measured positions for the portable electronic device. The computer program further comprises program element configured to calculate an activity rate by comparison of the calculated driving distance with a read driving distance, where the read driving distance is based on a reading of odometer indication of the vehicle. The computer program also comprises program element configured to calculate a flag which indicates the validity of the calculated activity rate, where the flag is calculated based on the sequence of measured positions for the portable electronic device.

Yet another aspect refers to a device for determining activity rate of a portable electronic device during travel with a vehicle. The device comprises means configured to determine a calculated driving distance based on the portable electronic device utilizing a sequence of measured positions for the portable electronic device. The device further comprises means configured to calculate an activity rate by comparison of the calculated driving distance with a read driving distance, where the read driving distance is based on a reading of odometer indication of the vehicle. The device also comprises means configured to calculate a flag which indicates the validity of the calculated activity rate, where the flag is calculated based on the sequence of measured positions for the portable electronic device.

### BRIEF DESCRIPTION OF THE DRAWINGS

The embodiments, together with further objects and advantages thereof, may best be understood by making reference to the following description taken together with the accompanying drawings, in which:

FIG. 1 is a flow chart for a method for obtaining activity rate according to an embodiment;

FIG. 2 shows an example of a system for obtaining activity rate according to an embodiment;

FIG. 3 shows the relation between the positions of a vehicle at time n and at time n+1;

FIG. 4 is a flow chart for a method for obtaining activity rate according to a particular embodiment;

FIG. 5 shows an example of calculation of an insurance premium according to an embodiment;

FIG. 6 shows a flow chart for a method for calculation of an insurance premium according to an embodiment;

FIG. 7 shows an example of calculation of driving distance according to an embodiment;

FIG. 8 shows a block diagram of a computer implementation for determining activity rate according to an embodiment; and

FIG. 9 shows a block diagram of a device for determining activity rate according to an embodiment.

### DETAILED DESCRIPTION

The present invention generally relates to portable electronic devices such as mobile phones and more particularly to a method for obtaining an activity rate of a portable electronic device during travel with a vehicle. As an example, the activity rate describes how much a mobile application installed in a mobile phone in a vehicle is used during travel in relation to the total driving distance of the vehicle.

Throughout the drawings, the same reference numbers are used for similar or corresponding elements.

To continue the discussion in the background section above: In order to enable implementation of monitoring of the driving behaviour via a mobile phone as described above, the vehicle owner, also the insurance holder, needs to activate his/her mobile phone in a correct manner when travelling with the vehicle. From several reasons said driver may forget his/her mobile phone, forget to activate it in a correct manner, alternatively for a period of time lend his/her vehicle to a temporary user. From the above observation it is clear that there is a need for a method for calculating the activity rate A, i.e. how large portion of the total driving distance of the vehicle that has been monitored by the vehicle owner's, also the insurance holder's, mobile phone; by correct activation of predetermined functionality.

The driving distance that has been monitored by the mobile phone can for example be calculated by the mobile phone, based on e.g. information from satellite based positioning systems, and/or mobile phone based positioning systems. Information about the actual driving distance of the vehicle is available for example from the odometer of the vehicle. Retrieved and calculated information may for example be sent to a central server at e.g. the insurance company, for example with wireless broadband or other wireless data communication.

When calculating the activity rate as described above it is also important to ensure that the calculated activity rate is reliable. For example, if the insurance holder activates the functionality for monitoring of driving behaviour when travelling with another means of transportation than the insured vehicle, the activity rate will be incorrectly increased. It is therefore important that a method for calculating the activity rate as described above also contains functionality for ensuring the reliability of the calculated activity rate, as well as functionality for flagging of improper influence of the calculated activity rate. It may also be of interest to flag for such cases when the functionality for monitoring of driving behaviour is not activated when travelling with the insured vehicle, which results in a lower activity rate than expected. How this validation of activity rate and flagging for cases when the activity rate is incorrect or otherwise differs from what is expected, is described in more detail below.

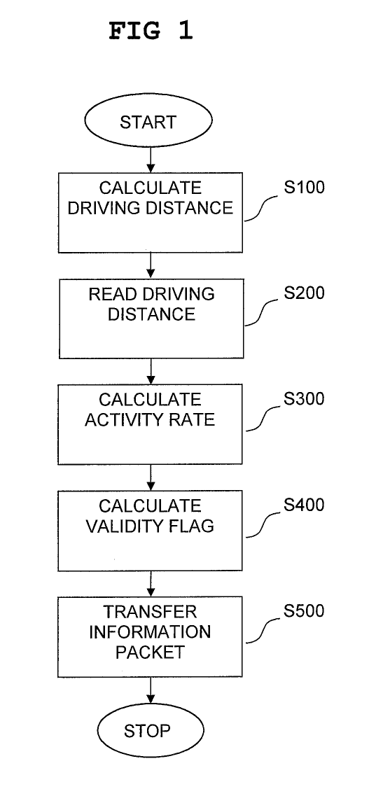

The present invention provides a method for obtaining activity rate of a portable electronic device during travel with a vehicle. With reference to FIG. 1 a method in accordance with the present invention generally comprises a step S100 of determining a calculated driving distance based on the portable electronic device utilizing a sequence of measured positions. The method further comprises a step S200 of determining a read driving distance by reading of odometer indication of the vehicle. The method also comprises a step S300 of calculating an activity rate by comparison of the calculated driving distance with the read driving distance. The method further comprises a step S400 of calculating a flag which indicates the validity of the calculated activity rate, where the flag is calculated based on the sequence of measured positions for the portable electronic device. The method also comprises a step S500 of transferring an information packet to a central server, where the information packet comprises the activity rate, and/or the read driving distance, and/or the flag.

The following concepts are defined and used in this description:
Vehicle driver or driver: the one driving a vehicle, regardless of if it is his/her own or someone else's vehicle.
Vehicle owner or owner: the one owning and insuring a vehicle. In Sweden the ownership is linked to a private person, or legal person. For simplicity in the discussion below this is limited to physical owners, but it is pointed out that the discussion also is valid for the case with legal entities as owners, with appropriate changes since only physical persons can be vehicle drivers. Registered owner should be the one who mainly uses the vehicle. Owner and user are usually the same person or organisation. An exception is if the owner leases out the vehicle for more than one year and reports it to the Swedish Transport Agency. Then the lease taker takes over the owner's responsibility to pay taxes and insurance. The lease taker then stands as user in the Traffic Registry. Unless otherwise indicated, the term vehicle owner or just owner is used exclusively in the description below.
Mobile phone: Refers to for example a mobile phone, i.e. a wireless phone which via subscription is linked to a person or legal person, and which uses connection with the mobile communications networks such as GSM, 3G, 4G etc. The introduction of so-called Smartphones such as iPhone and Android-based phones such as for example HTC Desire has increased the availability of the information technology the functionality of the mobile phone has been multiplied from being a device for voice calls to a device with a versatile field of application. Other devices with overlapping functionality comprise for example palm-pilots, tablets such as iPad and Android-based tablets such as Samsung Galaxy Tab P1000, notebooks, PC laptops or other general portable computer products where the functionality for the user may be adapted by downloading of computer programs from electronic market places such as App Store or Android Market or computer readable media such as CD, DVD, USB-memory, hard drive, etc. The invention applies to personal electronics as exemplified above, which for simplicity are given the collective name mobile phone. Modern mobile phones have after downloading of suitable functionality implemented via software modules support for functions such as imaging via photography, data transfer through wireless connection to a central server, and tagging with time and place via GPS or other satellite system or via positioning in the mobile phone networks, or combinations of both methods. Several satellite navigation systems exist such as for example GPS (United States NAVSTAR Global Positioning System), GLONASS (Russian Global Navigation Satellite System), Galileo (Europe), COMPASS (China) which are gathered under the collective name GNSS (Global Navigation Satellite System). An example of GNSS with support from local positioning with the aid of the mobile phone systems is assisted GPS (A-GPS). In particular GPS of the different GNSS-systems has had a major impact and GPS receivers are nowadays found in a majority of mobile phones, and in a great majority they have support for A-GPS. Apart from GPS, also GLONASS is nowadays standard, for example in iPhone from iPhone 4S. GLONASS is required for items sold in Russia, a fact that has pushed the chip development. Described devices also comprise other sensors such as accelerometers, gyroscope, microphone, thermometer, etc.

Together with a mobile phone a holding device is sometimes used in which the phone may be placed. The holding device may be attached for example to the dashboard in a car. Usually the device also comprises some kind of locking means to keep the phone in place also during motion, as well as a possibility to charge the battery of the phone through the electrical system of the vehicle. In order to enable attachment of different phone models into different vehicle models, either attachment devices of general type are used, or attachment devices consisting of a vehicle specific part and a phone specific part.

In many cases no holding device is used. In these cases charging of the phone may be done via a cable which in one end is connected to the mobile phone and in the other end is connected with a contact piece for example to the cigarette lighter outlet of the vehicle. However, in many cases no device for charging of the mobile phone is used when travelling with a vehicle.

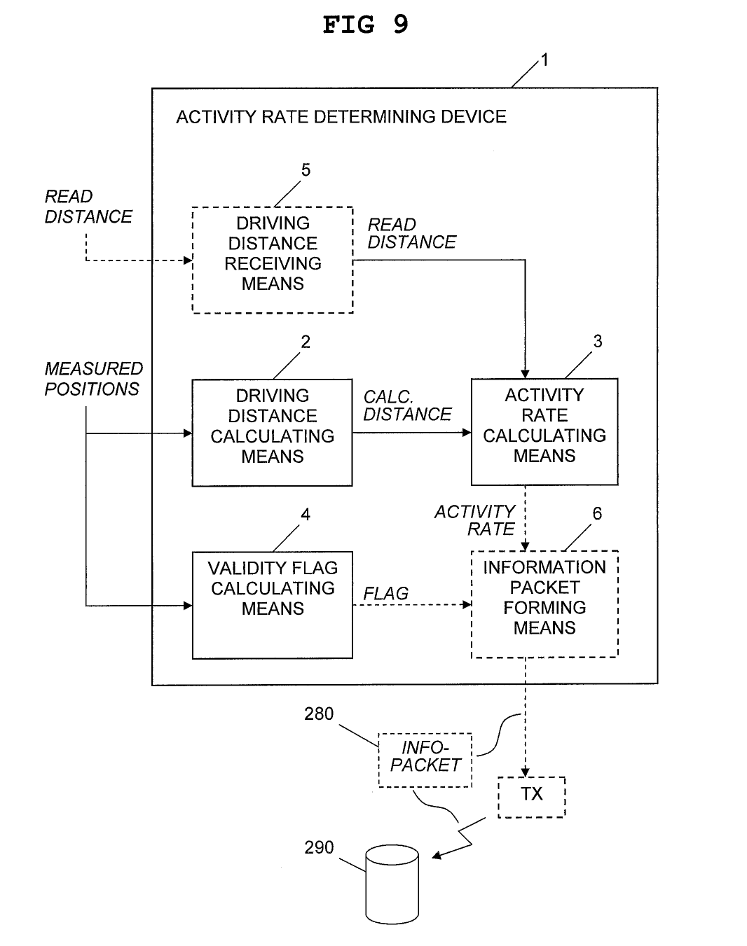

FIG. 9 shows a simple block diagram of an embodiment of a device 1 for determining activity rate of a portable electronic device during travel with a vehicle. The device 1 generally comprises means 2 configured to determine a calculated driving distance based on the portable electronic device utilizing a sequence of measured positions for the portable electronic device. The device 1 further comprises means 3 configured to calculate an activity rate by comparison of the calculated driving distance with a read driving distance, where the read driving distance is based on a reading of odometer indication of the vehicle. The device 1 also comprises means 4 configured to calculate a flag which indicates the validity of the calculated activity rate, where the flag is calculated based on the sequence of measured positions for the portable electronic device.

In one embodiment the device 1 further comprises means 5 (drawn with a dashed line to indicate that it is optional) configured to receive the read driving distance as input. Different ways for receiving the read driving distance are described in more detail below.

In a particular embodiment, the device 1 also comprises means 6 (drawn with a dashed line to indicate that it is optional) configured to form an information packet 280 for transfer to a central server 290, where the information packet comprises the activity rate, and/or the read driving distance, and/or the flag.

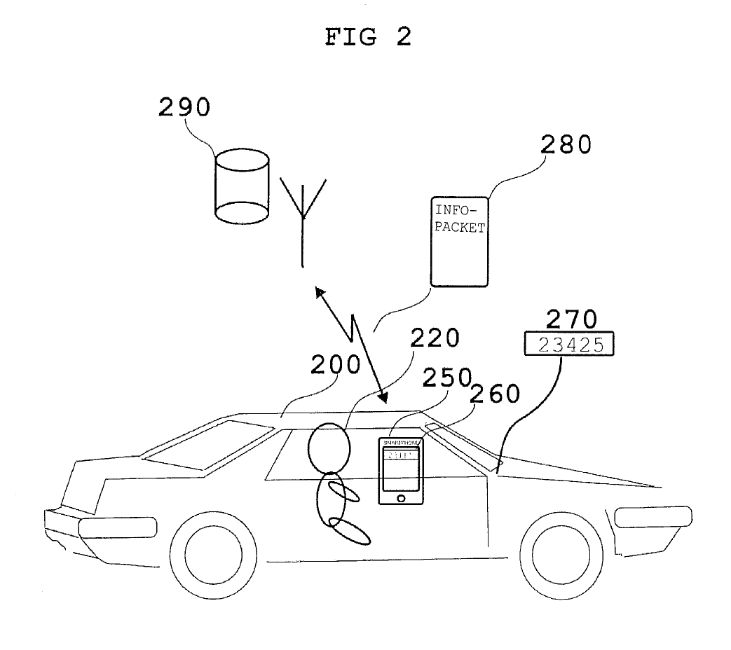

In one embodiment of the present invention, the measured positions for the portable electronic device are based on information from satellite based positioning systems, and/or mobile phone based positioning systems. FIG. 2 shows an example of a motor vehicle 200 with driver and also owner 220 according to an embodiment. The portable electronic device, a mobile phone 250 in this embodiment, calculates driven distance by summing up position differences available from the built-in GPS receiver or other GNSS receiver. The calculated driving distance may in one embodiment be shown via the mobile phone display 260. In another embodiment the calculated driving distance and/or other information relevant to the application may be sent to a central server 290 via mobile phone based wireless communication, conceptually in an information packet 280.

The relationship between said calculated driving distance and the actual driving distance of the vehicle, read through the odometer indication 270 of the vehicle, indicates the activity rate A of the mobile phone 250. The odometer indication 270 of the vehicle is in one embodiment indicated by a dedicated display in the instrument cluster of the car, comprising instruments such as speedometer, tachometer, fuel meter, clock, and warning lamps. In one embodiment reading of the odometer indication 270 is done optically, and in a particular example embodiment the reading of the odometer indication 270 is done with the aid of a built-in camera in the mobile phone 250.

The read driving distance of the vehicle corresponds to the actual driving distance of the vehicle, whereas the calculated driving distance corresponds to the monitored driving distance in an embodiment. Thus, the activity rate A together with the read driving distance determines the total activity, which in an embodiment also may be directly reported as read (actual) driving distance and calculated (monitored) driving distance.

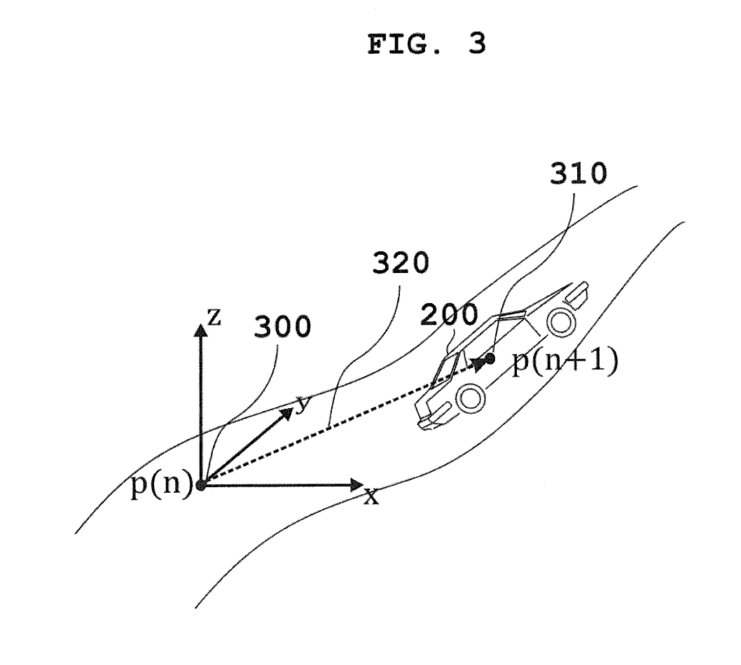

FIG. 3 shows examples of positions and traveled distance for the vehicle 200. In one embodiment the mobile application delivers positions 300 at regular intervals, the positions being denoted p(n) where p is a vector with x, y and z-coordinates, and n indicates the (unitless) time, or the sequence number of the measurement. Typically updates of position data from GPS are given every second which results in that p(n) and p(n+1) in one embodiment indicate two three-dimensional (3D) positions, for example via the standardized NMEA-protocol, for two consecutive times with a time interval of one second. In other embodiments, other satellite navigation systems and/or other update rates may be used. By comparing two consecutive positions, i.e. the current position p(n+1) 310 with the immediately preceding position p(n) 300 the traveled distance between the time n and time n+1 may be calculated via the Euclidian distance 320

$$d ( n + 1 ) = \sqrt{{( x ( n + 1 ) - x ( n ) )}^{2} + {( y ( n + 1 ) - y ( n ) )}^{2} + {( z ( n + 1 ) - z ( n ) )}^{2}}$$

where the quantities on the right hand side are x, y and z-coordinates of p(n) and p(n+1) respectively.

In one embodiment the traveled distances d(n) are summed up over all times when the mobile phone is used by the vehicle owner when he/she is the driver, which gives the totally covered distance with the application activated. We denote this distance with Smob, where

Smob=Σd(n)

where the summation is made over the times n during which the functionality is activated. Smob is thus in this embodiment calculated from a sequence of measured positions p(n), for a number of integer values of n.

If the update rate of the position data is slow relative to the speed of the vehicle, the estimation of Smob may in one embodiment be refined by using map information of available roads and properties such as speed limits, etc.

In another embodiment Smob may be calculated for example by using only the starting position and the ending position of the trip and then estimate Smob with the aid of a map based navigation function, where the most probable route (e.g. quickest route, fastest route, etc.) is estimated. This is well-known technique which is used for example in car navigators.

In an embodiment the insurance holder reports his/her actual driving distance of the vehicle with regular intervals by specifying odometer indication, read in a suitable manner from the odometer indication 270 of the odometer of the vehicle. In one embodiment reporting refers to entering via the keyboard of the mobile phone or other device, or in another embodiment via telephone, or in yet another embodiment via Internet. In a particular embodiment, the reading of the odometer indication 270 is done optically, for example via the built-in camera of the mobile phone 250 and known techniques for character recognition. From the odometer indication 270 the actual driving distance, which is denoted Smeas, may in one embodiment be calculated by subtracting from the current odometer indication a previous odometer indication, for example from the preceding reading.

If the calculation of Smob and Smeas starts from the same initial value of distance and time, the activity rate A (unitless) of the mobile application may in one embodiment be calculated as the ratio:

A=Smob/Smeas[unitless]

The activity rate A describes in one embodiment how large portion of the driving distance of the vehicle that has been driven with the vehicle owner's mobile phone activated in such a manner that the driving behaviour is monitored and may be a basis for a behaviour-based insurance premium. It is obvious that A is in the interval between zero and one.

It is essential that a method for calculating the activity rate as described above contains functionality for ensuring the reliability of the calculated activity rate, or equivalently the reliability of the corresponding calculated driving distance Smob, as well as functionality for flagging of improper influence of the calculated activity rate/driving distance. This is because Smob may be improperly incremented if the functionality for calculating Smob is activated incorrectly, for example when travelling with another means of transportation than the insured vehicle. Alternatively, Smob may be incorrectly prevented from being incremented when travelling with the insured vehicle, for example if the intended functionality for calculating Smob is unconsciously or consciously not activated.

Validation of Smob, which obviously is equivalent to validation of activity rate A, in the present invention comprises means for detecting or flagging for incrementation of Smob by another event than when travelling with the insured vehicle, here denoted flag of TYPE 1, and failure to increment Smob when travelling with the insured vehicle, here denoted flag of TYPE 2.

Examples of flags (flag) according to TYPE 1 and TYPE 2 are summarized below, followed by a detailed description later in the text.

| Name | Type | Flag value | Description |
|---|---|---|---|
| flag_{mean distance} | TYPE 1 | 0 or 1 | Flags for travel outside of the |
| | | | road network, e.g. by train, ferry, |
| | | | or airplane. |
| flag_{distance} | TYPE 1 | 0 or 1 | Flags for travel outside of the |
| | | | road network, e.g. by train, ferry, |
| | | | or airplane. |
| flagᵢₙₜₑᵣᵥₐₗ | TYPE 1 | 0 or 1 | Flags for travel with other than |
| | | | insured vehicle. |
| flag_{off} | TYPE 2 | 0 or 1 | Flags for missed activation |
| | | | between consecutive drives. |

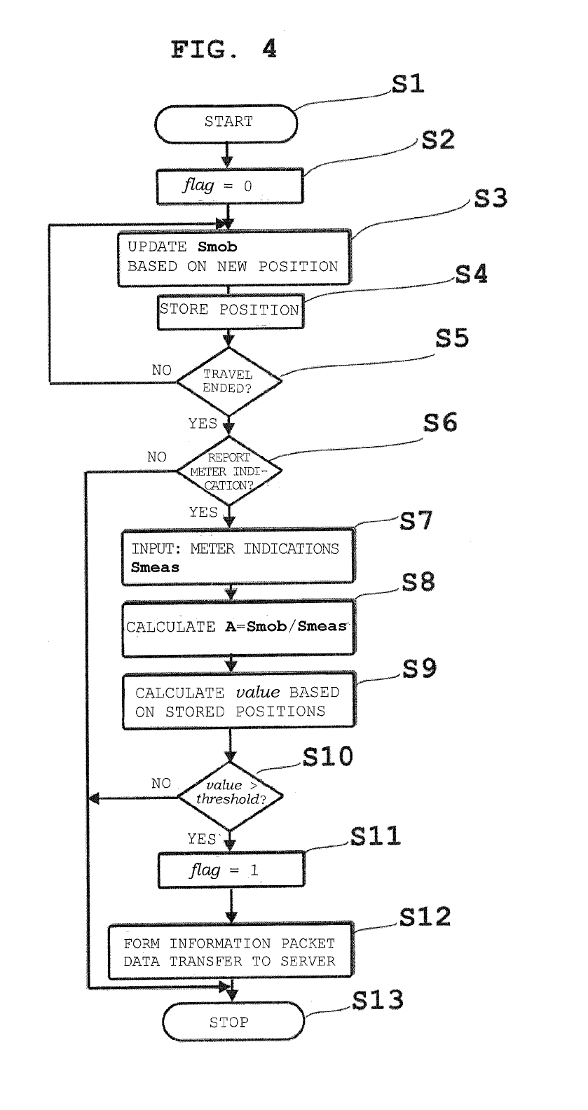

FIG. 4 shows a flow chart for a method according to an embodiment of the present invention. Here, a generic flag is defined as

flag=1 if value>threshold, otherwise flag=0

where threshold is a set threshold value and flag is for example one of or a combination of the flags described below. The value value can be calculated in a variety of ways, some of which are described in more detail below. The described methods for calculation of value have in common that value is based on said sequence of measured positions for the portable electronic device 250.

In one embodiment the flag may be vector-valued, i.e. consist of an incrementable set of scalar flags. The flag flag above may then for example be incremented each time a value value exceeds a threshold value threshold. In an embodiment where a binary flag is used (as shown for example in the table above) the concept of incrementing may refer to the process of changing the flag from zero to one.

Following the discussion above, the generic flag according to the embodiment in FIG. 4 can be expressed as being incremented when a value based on the measured positions for the portable electronic device 250 exceeds a threshold value.

In the example embodiment in FIG. 4 an information packet is formed consisting of activity rate A and flag flag which is sent to a central server 290.

Step S1 indicates the starting point for this embodiment of the method and may for example be initiated when the owner 220 activates the application for incrementation of Smob on his/her mobile phone 250.

In step S2 the flag flag is set to zero. In a particular embodiment the flag may be vector-valued, i.e. consist of an incrementable set of scalar flags with associated threshold values, which is exemplified later in this description.

In step S3 Smob is updated based on the latest position 310.

In the step S4 the positions p(n) or the distances d(n) are stored, which in a particular embodiment is implemented through the memory of the mobile phone.

The step S5 tests if the travel with the vehicle has ended. If that is the case, the flow proceeds to step S6. The test in step S5 may in one embodiment be done by the owner de-activating the application for incrementation of Smob on his/her mobile phone 250.

The step S6 tests if the owner should report the odometer indication of the vehicle to his/her insurance company. If that is the case, the flow continues to step S7, otherwise to step S13 which finishes the method. The test in step S6 may in one embodiment be done based on date or time of the year of the anniversary date of the insurance, for example by reading of the date via the mobile phone network or other electronic calendar. The test in step S6 may in another embodiment be done through driving interval indicated by Smob. In yet another embodiment, a test based on the combination of current date relative to the anniversary date of the insurance and driving interval Smob is used in order to achieve the best possible test for when it is time to report odometer indication.

The step S7 receives the odometer indication Smeas of the vehicle as an input. This may in one embodiment be done by the owner manually reading the odometer indication of the vehicle and entering the odometer indication via the keypad of the mobile phone 250, or in another embodiment via optical reading of the odometer indication, for example through the camera of the mobile phone 250 and known techniques for character recognition. Optical reading and recognition of numbers and text is a well-known technique and may be done with available methods, so-called OCR (optical character recognition).

Reading of odometer indication may in an embodiment be combined with validation of said odometer indication. In one embodiment the validation may be done by the owner entering for example a numerical code in connection with manual registration. In another embodiment the validation may be done with optical reporting, for example by the owner photographing identity markers. Identity markers may for example be the license plate of the vehicle, or the Vehicle Identification Number (VIN, chassis number) of the vehicle.

Step S8 in this embodiment calculates the activity rate A through the ratio:

A=Smob/Smeas[unitless]

Step S9 calculates a value value based on positions stored in step S3. A number of examples of calculation of value will be described in detail in the following text.

The step S10 tests if the value exceeds a corresponding threshold value. If that is not the case, the flow continues to step S13 which finishes the method. If the outcome of the step S10 is positive, the flow continues to step S11 which in this embodiment sets the flag to one, indicating that the activity rate A involves a higher probability than normal to be manipulated or from some other reason should be validated by additional measures.

Step S12 forms an information packet 280 by bringing together information such as for example activity rate A, flag flag, and/or supplementary information such as for example date and identity codes, associated photographs in digital format or other information relevant for ensuring the identity of the vehicle, owner or driver. In a preferred embodiment, the information packet 280 comprises at least the activity rate A and the flag flag. In one embodiment the information packet comprises Smob and Smeas which after processing, for example on the server, also yields the activity rate A. Step S12 also transfers said information packet 280 to server 290, in this embodiment via wireless technique provided via the mobile phone for example via 2G, 3G, 4G or WLAN or other standard for wireless communication.

Step S13 finishes the method.

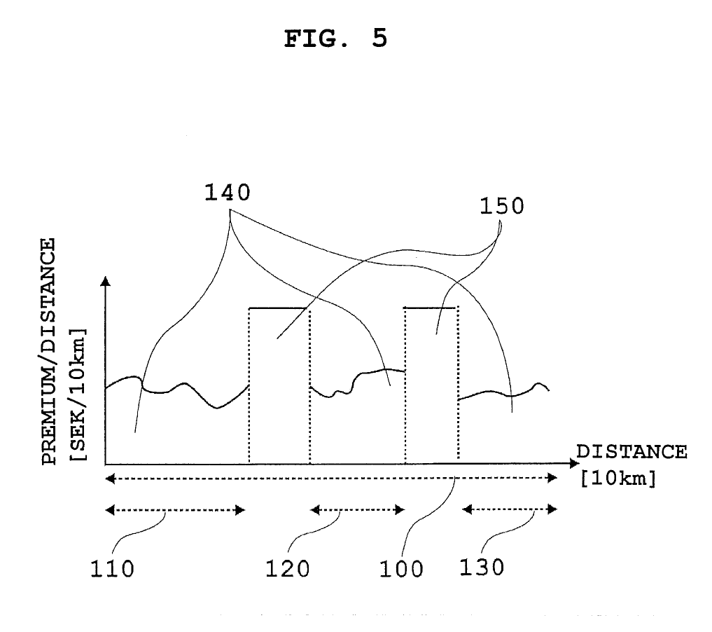

The method described in connection with FIGS. 1 and 4 may be used for calculating an insurance premium. FIG. 5 shows an example of how the activity rate may be used for calculating an insurance premium. In FIG. 5 the covered distance of the vehicle is indicated on the x-axis. For example, if a vehicle owner has a traditional vehicle insurance with premium P [SEK] based on the total driving distance 100 which for a behaviour-based premium model is replaced by

A·B+(1−A)·P

where (1−A)·P corresponds to the traditional premium which is used when the travel of the vehicle is not monitored, and the product A·B corresponds to the behaviour-based premium when the travel is monitored. If the activity rate is zero, the traditional premium calculation is used in full, while an always present monitoring of the driving behaviour during travel implies a behaviour-based premium. If B corresponds to a lower premium than P the vehicle owner is motivated to use his/her mobile phone for monitoring of the driving behaviour in order to achieve an activity rate A close to one, which gives a lower premium than the premium when the activity rate is low.

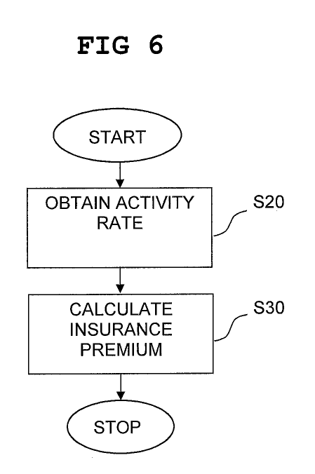

More generally speaking, and with reference to FIG. 6, a method for calculating an insurance premium according to an embodiment generally comprises a step S20 of obtaining the activity rate of a portable electronic device in a vehicle during travel according to any of the methods as described above. The method also comprises a step S30 of calculating the insurance premium by summation of a first part and a second part, where the first part increases when the activity rate increases and vice versa, the second part decreases when the activity rate increases and vice versa, and the insurance premium decreases when the activity rate increases.

In one embodiment, the insurance premium during a policy period of the insurance is calculated based on obtaining an activity rate during the policy period. In another embodiment the insurance premium during a policy period of the insurance is calculated based on obtaining an activity rate during a qualification period defined by a predetermined distance and/or time period, such that the qualification period is smaller than the policy period.

With reference again to FIG. 5 an example is given when the total driving distance 100 of the vehicle consists of five segments, or five travels with the vehicle, where the segments 110, 120 and 130 are the segments where behaviour-based premium is used. Depending on the momentary driving behaviour the momentary premium per ten km varies. The total behaviour-based premium B is then calculated as

$$B = {\int }_{monitored segments} b ( s ) d s$$

where b(s) is the momentary premium per distance unit, which is based on factors such as the above mentioned external, internal or behavioural factors, or combinations of these. The vehicle owner will then be motivated both to driving environment-friendly and with a low risk, which reduces the driving behaviour based premium B.

In the example above and with reference to FIG. 5 the monitored segments are said segments 110, 120 and 130 and B is thus given by the area 140 consisting of three partial areas. FIG. 5 also illustrates how the traditional premium P may be seen as a constant premium per distance unit times covered distance, illustrated by the area 150 comprising two rectangular partial areas. The vehicle owner is thus motivated both to drive in a way that reduces the driving behaviour based premium B, and to use his/her mobile phone for monitoring of the vehicle behaviour in order to achieve an activity rate A close to one, which gives a lower premium than when the activity rate is low (as long as B corresponds to a lower premium than P).

Examples of flags (flag) according to TYPE 1 and TYPE 2 were summarized above. Below follows a detailed description of different flags.

Example of Flag: flagᵢₙₜₑᵣᵥₐₗ

An obvious flag is if the calculated value of A is larger than one.

flagᵢₙₜₑᵣᵥₐₗ=1 if A>1, otherwise flagᵢₙₜₑᵣᵥₐₗ=0

Example of Flag: flag_{mean distance}

Navigational systems for vehicles or for portable use belong to a well-developed technology. The Swedish Research Institute of Trade, now HUI, has appointed “Christmas present of the year” since 1988, where the GPS receiver received the award in 2007. Apart from positioning via GPS, or other GNSS; possibly supported by data from so-called inertial sensors such as accelerometer and gyroscope, these navigators may use digital maps, for example maps of the road network, and conventional methods are then used for projecting measured position with position in the road network of the map. Digital maps are provided for example by companies such as NAVIGON, Tele-Atlas or public authorities such as Land Survey and the Swedish Transport Administration.

Again, let p(n) represent the position at time n, describing the position of the mobile phone at said time during calculation of Smob. An improper incrementation of Smob at time n may be flagged based on a calculation of the distance f(n) to the closest road, according to

f(n)={square root over ((x(n)−x0)²+(y(n)−y0)²+(z(n)−z0)²)}

where p0(n)=(x0, y0, z0) are the coordinates for the point in the road network which is closest to p(n).

Since f(n) is an instantaneous value a practical test implies testing for a large number of measuring points n. If we consider a window with N sequential measuring points a natural test variable is

$$F ( n ) = \frac{1}{N} {\sum }_{i = 0}^{N - 1} f ( n - i )$$

where F(n) is the average deviation in a historical window with end point time n.

A flag for improper updating of Smob by allowing incrementation outside of a geographical road network is obtained by testing F(n) or f(n) against a predetermined threshold value (in meters). If the outcome of the test is positive, the value of the flag is incremented.

To enable a running update of the test variable the above rectangular weighting of f(n) may be replaced with a so-called recursive updating,

F(n)=aF(n−1)+(1−a)f(n)

where a is a variable between zero and one. For a close to one this corresponds to a long window, i.e. a large value of N. A comparison of window length between the above two alternatives gives that N samples correspond to a value of a that is approximately given by a=1−1/N.

The test variable F(n) is an indicator of Smeas being incremented by travel outside of the mapped road network for vehicle bound traffic. Particularly if N is chosen so that all deviations during a travel from start to stop are registered the binary flag

flag_{mean distance}=1 if F(n)>threshold_{mean distance}, otherwise flag_{mean mean distance}=0

is obtained, where flag_{mean distance} indicates that the mean distance from the road network is larger than a set threshold value threshold_{mean distance}. threshold_{mean distance} is a predetermined threshold value which indicates the allowed maximum deviation of the mean distance of the vehicle from the road network during the trip, according to the digital map.

Example of Flag—Distance Deviation: flag_{distance}

On access of a digital map the measured position at time n, i.e. p(n), is projected to the closest position on the road map through conventional methods for projecting measured position with position in the road network. Since a digital map is comprised of road segments with a given length the covered distance may alternatively be calculated as the sum of the lengths of all segments during a trip. An alternative to Smob is thus

Ssegment=Σsegment lengths.

The difference in distance |Ssegment−Smob| should be smaller than a threshold value in order not to generate a warning flag.

flag_{distance}=1 if |Ssegment−Smob|>threshold_{distance}, otherwise flag_{distance}=0

threshold_{distance} is a predetermined threshold value which indicates the allowed maximum deviation of the calculated distance of the travel when compared to the distance according to the road network of the digital map.

The two above described examples of flags (flag_{mean distance} and flag_{distance}) can be described as an embodiment of the method according to the present invention, where the flag is calculated based also on digital map data, through at least one of the following measures:
deviation in mean distance between the measured positions and positions obtained form the digital map data,
deviation in distance between the calculated driving distance and a distance obtained from the digital map data.

Example of Flag: flag_{off}

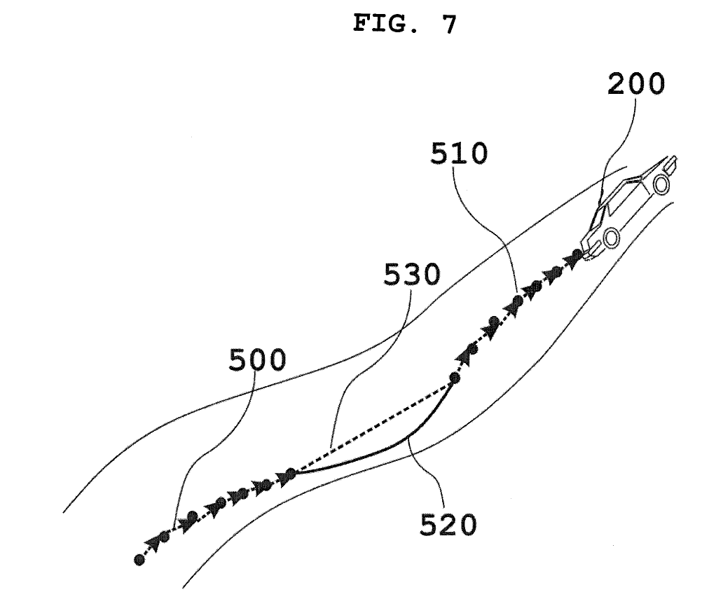

Other means may also be used to ensure the validity of the calculated driving distance Smob. Consider the basic example in FIG. 7, where the driving distance of the vehicle consists of the three segments 500, 510 and 520. The actual driving distance Smeas is in this case equal to the sum of the lengths of the three segments 500, 510 and 520. In this example the driver and also the owner of the vehicle has however used the functionality of the mobile phone only at the trips corresponding to the distances 500 and 510. When travelling the distance 520 Smob has not been incremented, for example because the vehicle has been lent, the mobile phone has unintentionally been forgotten to be brought on the travel by the owner and also the driver, or alternatively unintentionally forgotten to be activated in a correct manner. In this example Smob is thus updated only during the segments 500 and 510, and not during travel along the segment 520. In this simple example Smob is thus given by the sum of the lengths of the segments 500 and 510.

By calculating the distance 530 from the preceding deactivation of the functionality in said mobile phone (an end point Pend in segment 500), and the subsequent activation (a starting point Pstart in segment 510) and denote this distance Soff another flagging can be made, since

Smob≦Smob+Soff≦Smeas.

The left inequality in the equation above is fulfilled when the segment 520 is a segment with the same starting as end point (a round trip), while the right is fulfilled if the trip is along a straight line. From the above it is obvious that flagging should be done if the calculated value A fulfils

A>1

which according to the prior is the same as flagᵢₙₜₑᵣᵥₐₗ.

By using the second inequality the requirement can be tightened, i.e. flagging when

Soff>Smeas−Smob

i.e.

flag_{off}=1 if Soff>threshold_{off}(Smeas−Smob), otherwise flag_{off}=0.

Here, Soff is obtained by summing together all the distances between the previous end point and the next starting point. When the application is started the current position of the mobile phone is compared with the position of the mobile phone at the latest stop of the application. This gives an “instantaneous” value of Soff. If all these values are summed up the total Soff is obtained. threshold_{off} is a predetermined multiplicative value which indicates the allowed maximum deviation in distance.

As an alternative, several threshold levels may be used to differentiate detection of events. For example, the generic flag flag, given e.g. by any of said above flags, may have integer numbers 0, 1, 2, 3, 4, . . . where each strictly positive value corresponds to a higher threshold value. In such a manner a differentiation of measures at flagging may be done, such as information messages to the user at low flag value and cancellation of the insurance at high flag value.

It can also be noted that the above flags are all functions of a sequence of measured positions p(n), for a number of integer values of n.

Measures at set flag may vary. A flag of TYPE 1 indicates an elevated risk that the application is used in improper contexts such as travel with other means of transportation such as rail-bound or boat, or in another motor vehicle than that the application is intended for, whereas a flag of TYPE 2 indicates failure to activate the functionality for monitoring of the travel. As described above, the vehicle owner is motivated to activate his/her mobile phone to achieve a high activity rate in order to get a low insurance premium. A flag of TYPE 1 may indicate that the vehicle owner is trying to “cheat” in order to get a higher activity rate and thus a lower insurance premium, and therefore a flag of TYPE 1 may perhaps be considered as being more “serious” than a flag of TYPE 2. Hence, it may be of interest to the insurance company to be able to vary the measures at set flag depending on the type of flag.

The present invention may be implemented as a microprocessor, a digital signal processor (DSP), or a combination with corresponding software. In an embodiment a laptop is used with connected GPS, camera and wireless modem. The method may then be implemented as a computer program which is installed in the computer via computer readable media such as CD, DVD, USB memory, hard drive etc. The steps of the method are then performed by program elements in this program. Another possible implementation is to use programmable logic in FPGA (Field Programmable Gate Arrays) or ASIC (Application Specific Integrated Circuit).

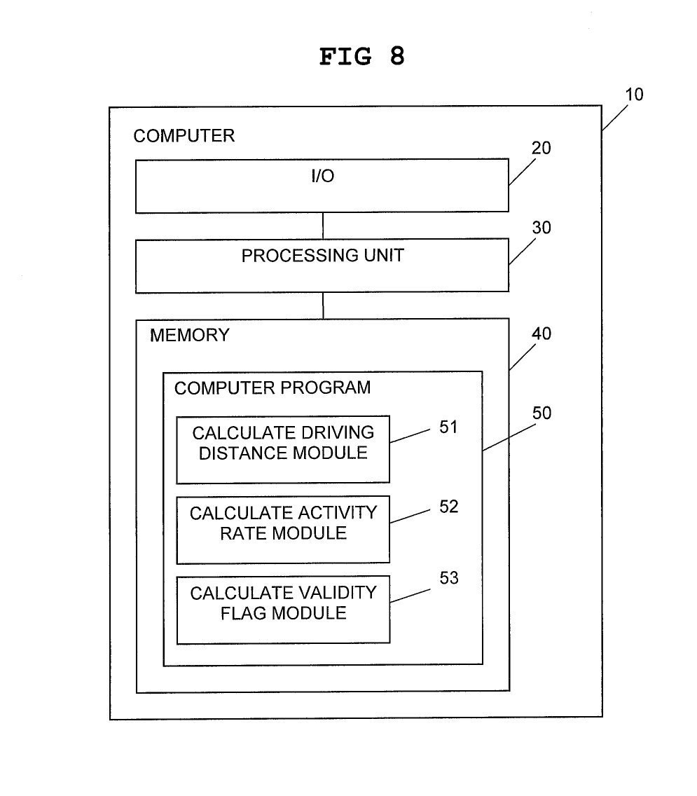

An example of a computer implementation is shown in FIG. 8. A computer 10 comprises a general input/output (I/O) unit 20 in order to enable input of for example a read driving distance, and output of the retrieved and calculated information, a processing unit 30, such as a DSP (Digital Signal Processor) or CPU (Central Processing Unit). The processing unit 30 can be a single unit or a plurality of units for performing different steps of the method described herein. The computer 10 also comprises at least one computer program product 40 in the form of a non-volatile memory, for instance an EEPROM (Electrically Erasable Programmable Read-Only Memory), a flash memory or a disk drive. The computer program product 40 in an embodiment comprises computer readable program means and a computer program 50, stored on the computer readable program means, for determining, when executed by a computer 10, activity rate of a portable electronic device during travel with a vehicle.

The computer program 50 comprises program elements 51-53 which when run by a processing unit 30 causes the processing unit 30 to perform at least some of the steps of the method described in the foregoing in connection with FIGS. 1 and 4. Hence, in an embodiment the computer program 50 comprises program element 51 configured to determine a calculated driving distance based on the portable electronic device utilizing a sequence of measured positions for the portable electronic device. The computer program 50 further comprises program element 52 configured to calculate an activity rate by comparison of the calculated driving distance with a read driving distance, where the read driving distance is based on a reading of odometer indication of the vehicle. The computer program 50 also comprises program element 53 configured to calculate a flag which indicates the validity of the calculated activity rate, wherein the calculation of a flag is based on the sequence of measured positions for the portable electronic device.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for obtaining an activity rate of a portable electronic device during travel with a vehicle, the method comprising:
retrieving a sequence of measured positions for the portable electronic device;
determining a calculated driving distance based on the portable electronic device utilizing the sequence of measured positions;
determining a read driving distance by reading an odometer indication of the vehicle;
calculating the activity rate by comparison of the calculated driving distance with the read driving distance;
calculating a flag which indicates the validity of the calculated activity rate, wherein the flag is calculated based on the sequence of measured positions for the portable electronic device; and
transferring an information packet to a central server, the information packet including at least one of
the activity rate,
the read driving distance, and
the flag.

2. The method according to claim 1, wherein the flag is incremented when a value based on the measured positions for the portable electronic device exceeds a threshold value.

3. The method according to claim 1, wherein the sequence of measured positions is based on information from at least one of
satellite based positioning systems, and
mobile phone based positioning systems.

4. The method according to claim 1, wherein transferring the information packet to a central server is done via mobile phone based wireless communication.

5. The method according to claim 1, wherein the flag is calculated based also on digital map data, through at least one of
deviation in mean distance between the measured positions and positions obtained from the digital map data, and
deviation in distance between the calculated driving distance and a distance obtained from the digital map data.

6. The method according to claim 1, wherein reading the odometer indication is done optically.

7. The method according to claim 1, wherein calculating the activity rate is done by calculating a ratio between the calculated driving distance and the read driving distance.

8.-10. (canceled)

11. A computer program for determining, when executed by a computer, an activity rate of a portable electronic device during travel with a vehicle, the computer program comprising:
a first program element configured to determine a calculated driving distance of the portable electronic device utilizing a sequence of measured positions for the portable electronic device;
a second program element configured to calculate the activity rate by comparison of the calculated driving distance with a read driving distance, where the read driving distance is based on a reading of an odometer indication of the vehicle; and
a third program element configured to calculate a flag which indicates the validity of the calculated activity rate, wherein the flag is calculated based on the sequence of measured positions for the portable electronic device.

12. A device for determining an activity rate of a portable electronic device during travel with a vehicle, the device comprising:
first means for retrieving a sequence of measured positions for the portable electronic device, and for determining a calculated driving distance of the portable electronic device utilizing the sequence of measured positions;
second means for calculating the activity rate by comparison of the calculated driving distance with a read driving distance, where the read driving distance is based on a reading of an odometer indication of the vehicle; and
third means for calculating a flag which indicates the validity of the calculated activity rate, wherein the flag is calculated based on the sequence of measured positions for the portable electronic device.

13. The device according to claim 12, further comprising:
fourth means for receiving the read driving distance as input.

14. The device according to claim 12, further comprising:
fifth means for forming an information packet for transfer to a central server, where the information packet includes at least one of
the activity rate,
the read driving distance, and
the flag.
